(19) United States
(12) Patent Application Publication
(10) Pub. No.: US 2014/0047960 A1
(43) Pub. Date: Feb. 20, 2014

(54) METHOD AND DEVICE FOR MAKING TOWELETTES

(71) Applicant: William E. KEARNEY, Batavia, OH (US)

(72) Inventor: William E. KEARNEY, Batavia, OH (US)

(21) Appl. No.: 13/584,865

(22) Filed: Aug. 14, 2012

(51) Int. Cl. B26D 1/00

(52) U.S. Cl. 83/13; 83/663

(57) ABSTRACT

A method and device for cutting a pleat-folded web material into a plurality of pleat-folded towelettes. A cutting station has one or more rotary knives that rotates axially and carry a one or more blades having a non-linear, typically curved, cutting edge. The pleat-folded web passes continuously through the cutting station in a direction transverse to the axis of the rotary knife, and is severed into units of pleat-folded towelettes by the cutting edge of the rotary knife at a predetermined length.

### FIELD OF THE INVENTION

The field of the present invention generally relates to packaged towelettes, and more particularly, to the cutting of pleat-folded towel material into individual towelettes.

### BACKGROUND OF THE INVENTION

An assembly line-like apparatus for the creation of individually packaged moist towelettes has been available since the 1960s. U.S. Pat. No. 3,286,435 to Weinberger et al., discloses an apparatus having a folding station, a cutting station, and a stuffing station. A similar apparatus is disclosed in U.S. Pat. No. 3,481,099 to Clancy et al. Another more recent apparatus is disclosed in U.S. Pat. No. 3,973,373 to Williams et al.

### SUMMARY OF THE INVENTION

The present invention provides a method for cutting a pleat-folded web material into a plurality of pleat-folded towelettes, comprising the steps of: 1) providing a cutting station that includes a rotary knife that rotates around an axis, the rotary knife including at least one blade having a non-linear cutting edge; 2) passing continuously a pleat-folded web through the cutting station in a direction transverse to the axis of the rotary knife; 3) rotating the rotary knife in a rotation direction of the passing through direction of the pleat-folded web, to sever the pleat-folded material with the non-linear cutting edge at a predetermined length and along a non-linear cutting line, to form a plurality of pleat-folded towelettes.

The present invention also provides a rotary knife for cutting a towelette from a web of continuously longitudinally moving pleat-folded material, comprising a rotary drum and at least one non-linear blade extending from a periphery of the rotary drum, the at least one non-linear blade having a non-linear cutting edge.

An aspect of the present invention is a rotary knife and a method for cutting a pleat-folded web of material with the rotary knife, that severs the end of the pleat-folded material at a predetermined length into pleat-folded units along a non-linear sever line.

Another aspect of the present invention is a curved blade for a rotary knife having a non-linear, preferably curved cutting edge.

A further aspect of the present invention is an insert on which one or more blades is disposed. The insert is secured into a corresponding channel in the periphery of the rotary knife.

Another aspect of the present invention is a method of orienting the blade so that the end portions of the curved cutting edge lead the blade toward the pleat-folded web during the cutting.

Another aspect of the present invention is a method including synchronizing the linear speed of the pleat-folded web to the tangential speed of the cutting edge of the blade of the rotary knife.

From the foregoing disclosure and the following more detailed description of the various preferred embodiments it will be apparent to those skilled in the art that the present invention provides a significant advance in the technology and art of wet towelettes and their creation. Additional features and advantages of various preferred embodiments will be better understood in view of the detailed description below.

### BRIEF DESCRIPTION OF THE DRAWINGS

These and further features of the present invention will be apparent with reference to the following description and drawings wherein:

FIG. 1 is a schematic drawing of an apparatus of the invention, comprising a cutting station including a rotary knife, for making and packaging units of pleat-folded towelettes.

FIG. 2 is a perspective view of the cutting station with the rotary knife and curved blade of FIG. 1.

FIG. 3 is an elevation view of the rotary knife and the knife blade of FIG. 2 taken along line 3-3 of FIG. 2.

FIG. 4 is a plan view of the rotary knife and the knife blade of FIG. 2 taken along line 4-4 of FIG. 2.

FIG. 5 is a plan view of a severed, pleat-folded towelette made using the rotary knife of FIG. 2.

FIG. 6 is a plan view of an alternate severed, pleat-folded towelette made by an alternate knife blade.

FIG. 7 and FIG. 8 are plan views of the unfolded towelettes of FIG. 5 and FIG. 6, respectively.

FIG. 9 is a plan view of the severed, pleat-folded towelette of FIG. 5.

FIG. 10 is a plan view of the folded towelette of FIG. 9 packaged within a sealed film pouch.

FIG. 11 is a plan view of the film pouch of FIG. 10 after opening along a tear line to provide removal access to the packaged towelette.

FIG. 12 is an alternative plan view of the unfolded towelette of FIG. 7.

FIG. 13 is a top view of the pleat-folded towelette, with the bottom view being the same.

FIG. 14 is a front view of the pleat-folded towelette of FIG. 13.

FIG. 15 is a back view of the pleat-folded towelette of FIG. 13.

FIG. 16 is a right side view of the pleat-folded towelette of FIG. 13.

FIG. 17 is a left side view of the pleat-folded towelette of FIG. 13.

The appended drawings are not necessarily to scale, and are illustrative of the basic principles of the invention. The specific design features of apparatus as disclosed herein, including, for example, specific dimensions, orientations locations, and shapes of the various components, will be determined in part by the particular intended application and use environment. Certain features of the illustrated embodiments have been enlarged or distorted relative to others to facilitate visualization and clear understanding. In particular, thin features may be thickened for clarity or illustration.

### DETAILED DESCRIPTION OF THE INVENTION

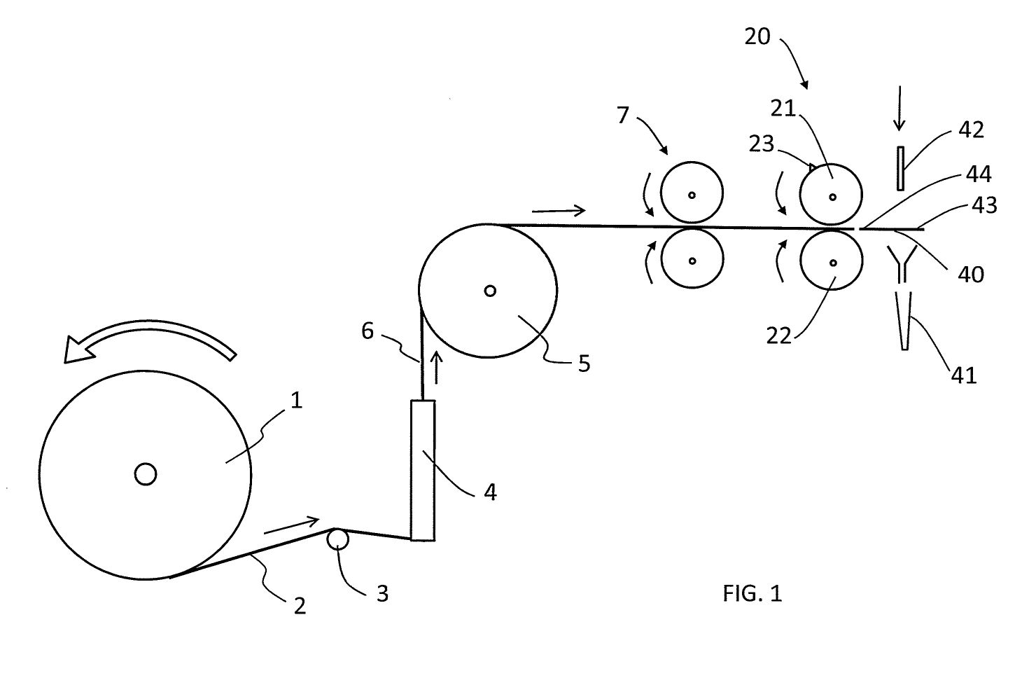

An embodiment of the present invention is shown in FIGS. 1-3 as a process for forming pleat-folded towelettes, where a continuous, longitudinally-moving web 6 of pleat-folded material is cut into units of predetermined length at a cutting station 20, and which are packaged within foil pouchs 41. A detailed description of an apparatus and method for forming, cutting and packaging a pleat folded towelette has been shown by Weinberger et al. U.S. Pat. No. 3,286,435, Williams, Sr. et al U.S. Pat. No. 3,973,373, and Clancy et al. U.S. Pat. No. 3,481,099, the disclosures of which are incorporated herein by reference in their entireties. A mill roll 1 unrolls a web of towel material 2 over an idle roller 3 and into a fan folder 4 to form a pleat-folded web 6. The continuously-moving pleat-folded web 6 moves across a breaker roller 5 into the pinch of a pair of pull rollers 7 that pull the pleat-folded material 6 tight and push the web 6 forward to the cutting station 20.

The cutting station 20 comprises a rotary knife 21 and an anvil drum 22. The rotary knife 21 comprises one or more blades 23 that sever the pleat-folded web 6 into individual towelettes 40 units of a desired length and the pre-determined shape. The present invention provides a non-linear blade 23 that cuts the leading end edge 43 and the trailing end edge 44 of each towelette 40 in a non-linear, including a curved, shape. The severed pleat-folded towelette 40 is then folded in half along its lateral centerline 45 and pushed into a film pouch 41 using an insertion dive arm 42. A liquid solution, including a cleaning or other liquid composition, can sprayed into the interior of the film pouch 41 prior to or after the severed pleat-folded towelette 40 is inserted. The filled foil pouch 41 is then cleaned, and sealed to form a single-use towellette package 48 (FIG. 10).

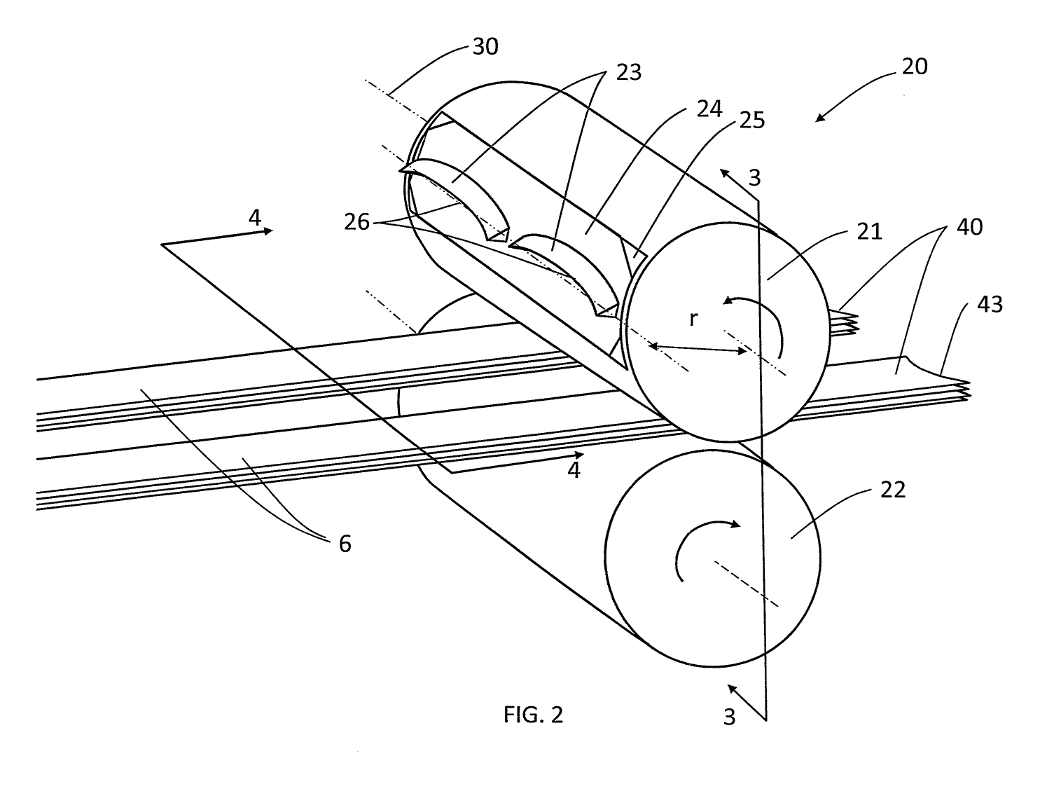

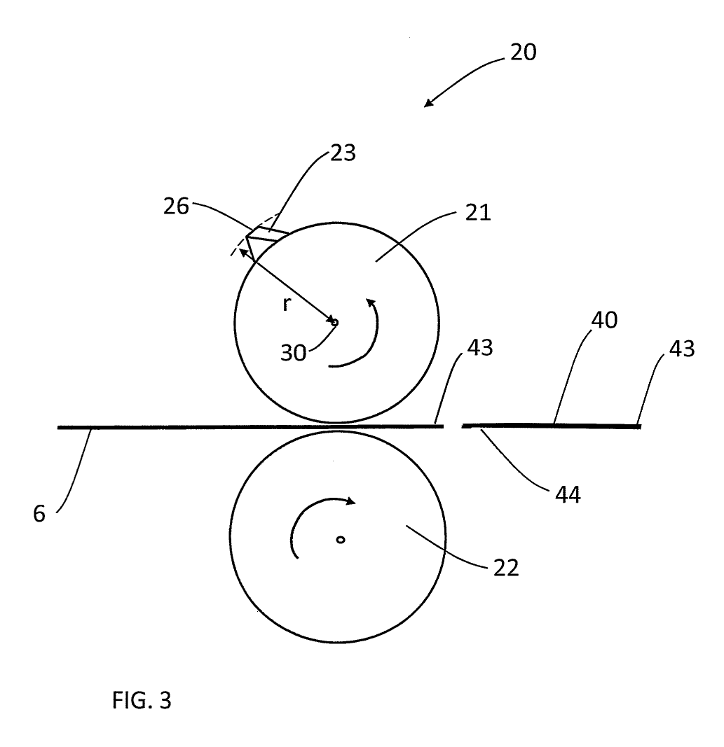

FIGS. 2 and 3 show a pair of pleat-folded webs 6 moving through the cutting station 20 between a rotary knife 21 that has a pair of curved blades 23, and an anvil drum 22. The pair of curved blades 23 have a non-linear cutting edge 26 that crush cut the pleat folded webs 6 into individual units of a pleat-folded towelette 40 at a predetermined length against the anvil drum 22 with each rotation of the rotary knife 21. The pair of curved blades 23 are formed as an integral part of an insert 24 that is inserted and secured into a complimentary channel 25 formed into the peripheral surface of the rotary knife 21. The insert 24 is secured with typical securing means, such as bolts (not shown) inserted through the opposite side of the drum of the rotary knife drum that thread into the base of the insert 24. The insert 24 can be easily removed and replaced with a different insert having differently shaped or sized blades, or the same if worn or broken, without needing to purchase an entirely new rotary knife 21.

The web material can be any woven or non-woven fibrous material including hydrophilic and/or hydrophobic fibrous or formed webs.

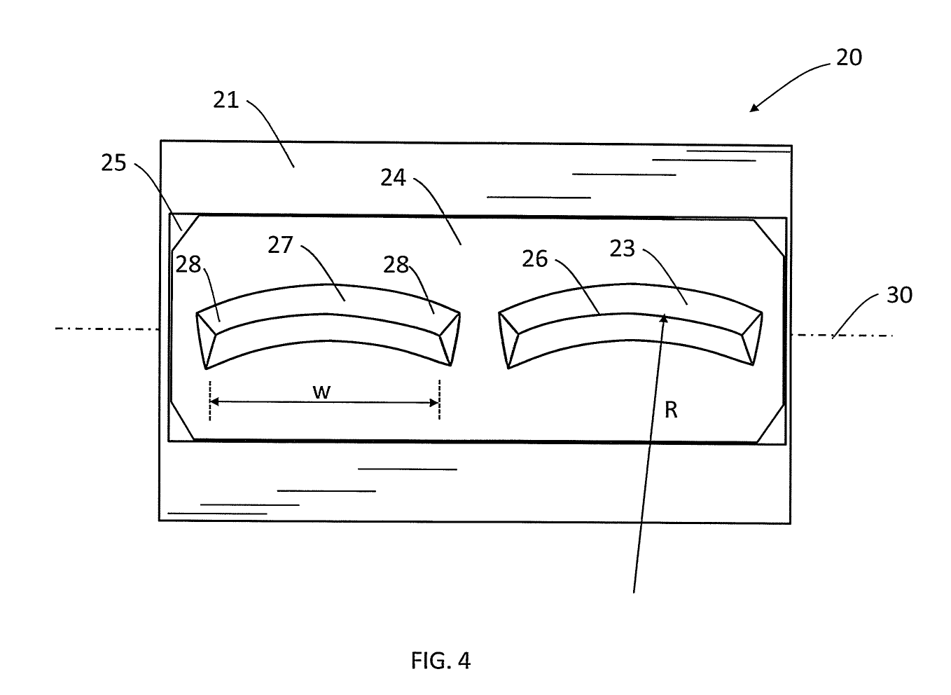

FIG. 4 illustrates a plan view of the rotary knife, showing the blades 23 having curved cutting edges 26, with a curved shape having a center portion and two end portions 28. The curved cutting edge 26 can have an arc with a radius “R” in relation to the radius “r” (FIGS. 2 and 3) to the cutting edge 26 of the rotary knife 21 (from the axis 30). Each point along the edge 26 of the blade 23 is a radial distance “r” from the axis 30 to ensure a proper crush cutting as the blade 23 passes across the anvil drum 22. In the illustrated embodiment, the ratio of the radius “R” to the radius “r” is about 1.5-1.0. It would be understood that other ratio of R″ to “r” can be used depending upon the desired curvature of the end cuts and the mechanical devices used for cutting. It would also be understood that only one blade might be used on an insert, or that two inserts or more can be installed on a rotary knife drum laterally side-by side, or circumferentially spaced along the periphery, as the need and design might require. It would also be understood that the non-linear shape of the blade can take many forms and shapes, including symmetrical and non-symmetrical shapes, curves with one or more inflection points, linear and curvilinear cutting edge portions, and combinations thereof.

FIG. 2 also illustrates a method of using the rotary knife of the invention for cutting the pleat-folded web 6 into individual towelettes 40. The pair of curved blades 23 are oriented parallel to the rotational axis 30 of the drum of the rotary knife 21. Blade 23 can rotate in the direction of its concavity, so that the end portions 28 lead or precede the center portion of the edge toward the pleat-folded web, or alternatively in the opposite direction. As the blade 23 approaches the web 6, the end portions 28 of the cutting edge 26 first contact the pleat-folded web 6 along its longitudinal side edges. This facilitates pulling of the pleat-folded web 6 forward evenly through the cutting station through the rotary knife 21 and anvil drum 22. The rotary knife 21 and the anvil drum 22 are positioned parallel and spaced apart laterally to maintain a crush contact of the curved cutting edge 26 of the blade 23 onto the peripheral surface of the anvil drum 22 with each rotation, which is sufficient to sever the pleat-folded web 6 into the individual towelettes 40.

The longitudinal center of the pleat-folded web 6 is aligned with the center 27 of the curved blade 23 for proper cutting of the curved shape. The width “w” of the cutting edge 26 of the blade 23 should be greater than the width of the pleat-folded web 6, and sufficiently greater so that the entire width of the web 6 is cut through, even if the tracking of the web 6 under the rotary knife 21 wanders a little.

The method of cutting the pleat-folded web 6 can include the steps of: feeding the pleat-folded web 6 through the cutting station at a linear speed that is synchronized to the tangential speed of the cutting edges 26 of the blades 23. Synchronizing the speeds helps to avoid stretch or slack in the web 6, and facilitates aligned movement of the pleat-folded web 6 through the cutting station 20. In this embodiment the pull rollers 7 have tangential speed that imparts a linear speed to the pleat-folded material that is equal to the tangential speed of the cutting edges 26.

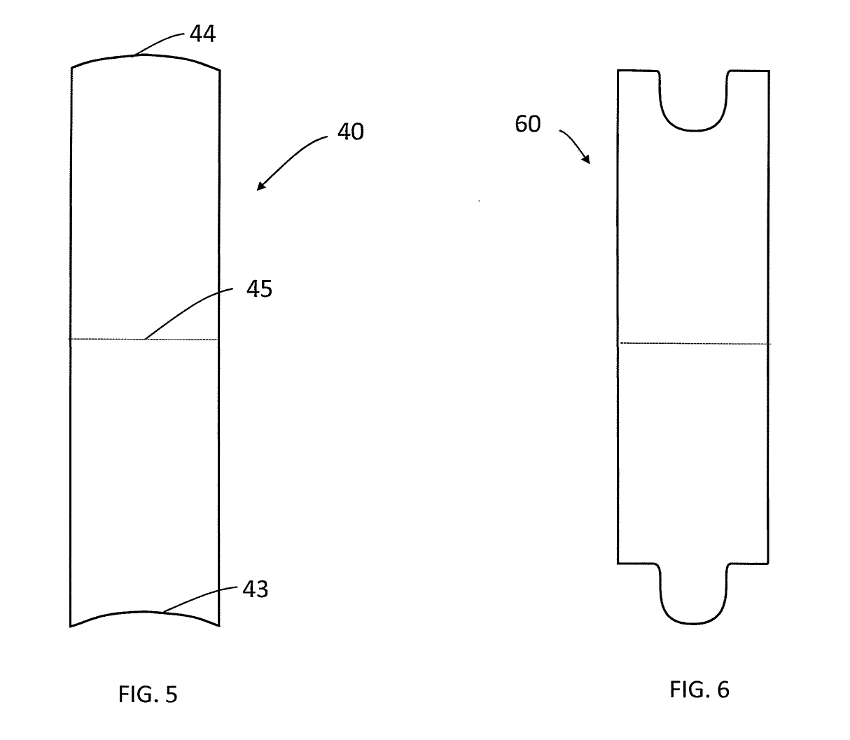

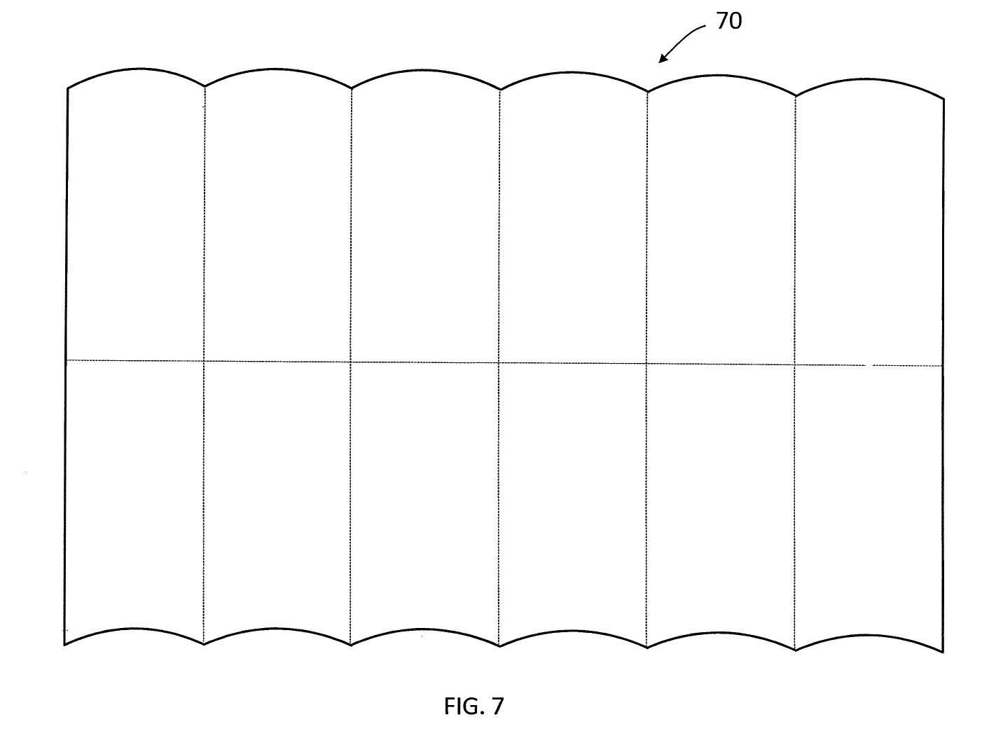

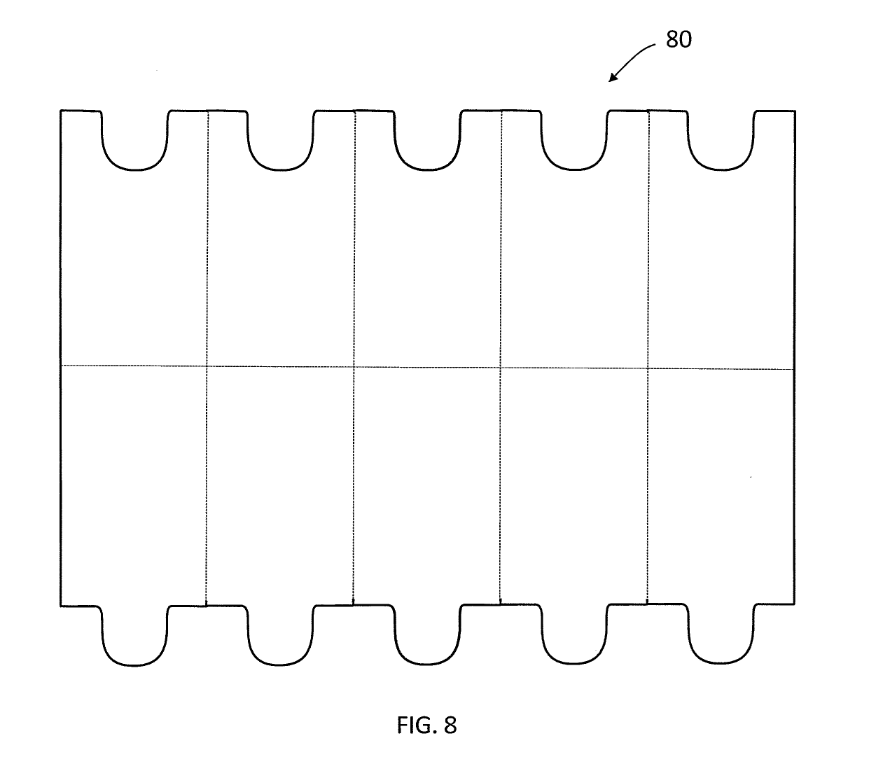

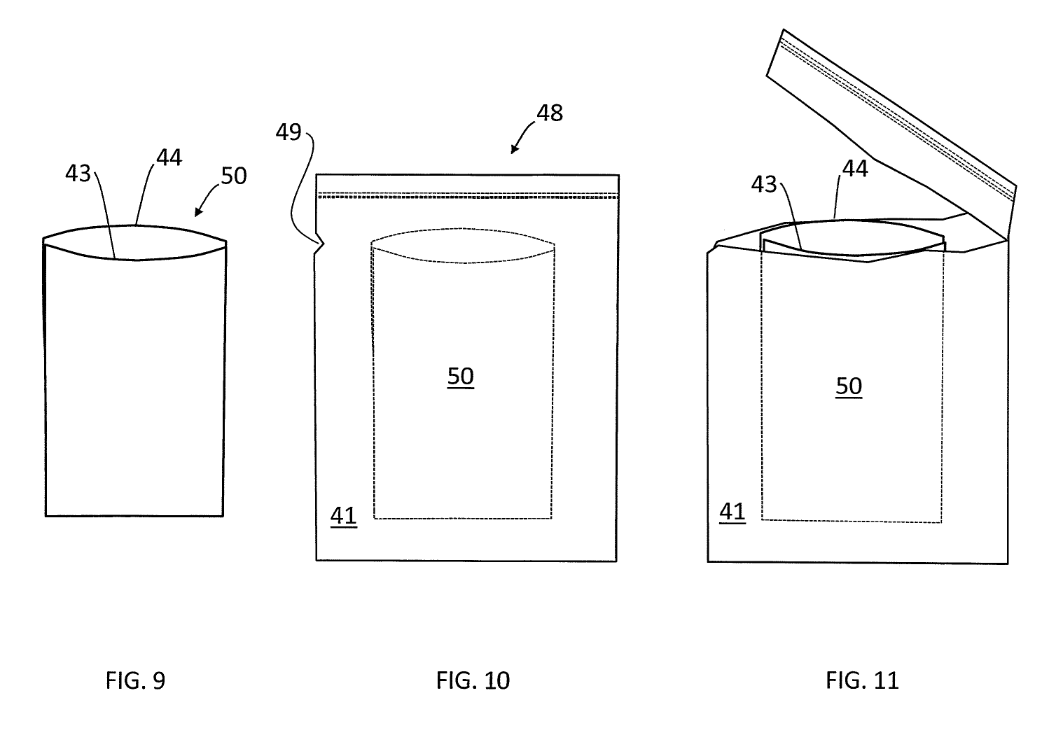

FIG. 5 shows a piece of pleat-folded towelette 40 after being severed from the web 6 with the curved blade 23. The severed, pleat-folded towelette 40 has a leading curved edge 43 and a trailing curved edge 44 at opposite ends that are identically oriented, resulting in one end edge being concave and the other end edge being convex. Lateral centerline 45 bisects the length of the towelette 40, along which the towelette is folded and stuffed into the film pouch 41 via an insertion dive arm 42. The similar orientation of the end edges of the towelette provides the folded towelette 50 with a unique appearance as shown in FIG. 9, and gives the edges of the unfolded towelette 70 a scalloped appearance as shown in FIG. 7.

FIG. 6 is an example of an alternate embodiment of the invention, where a pleat-folded towelette 60 is formed using a differently-shaped non-linear blade for cutting the pleat-folded web. FIG. 8 shows the unfolded towelette 80 from the pleat-folded towelette 60 shown in FIG. 6.

FIG. 10 shows a folded towelette 50 packaged within the film pouch 41 having a tear notch 49 that is sealed to form a towelette pouch product 48. Upon opening with the tear notch along the top edge of the sealed pouch, as shown in FIG. 11, the towelette 50 exposed the opposed concave edge 43 and convex edge 44 to the user for grasping, which allows the user to more easily pull the towelette 50 out of the opened film pouch.

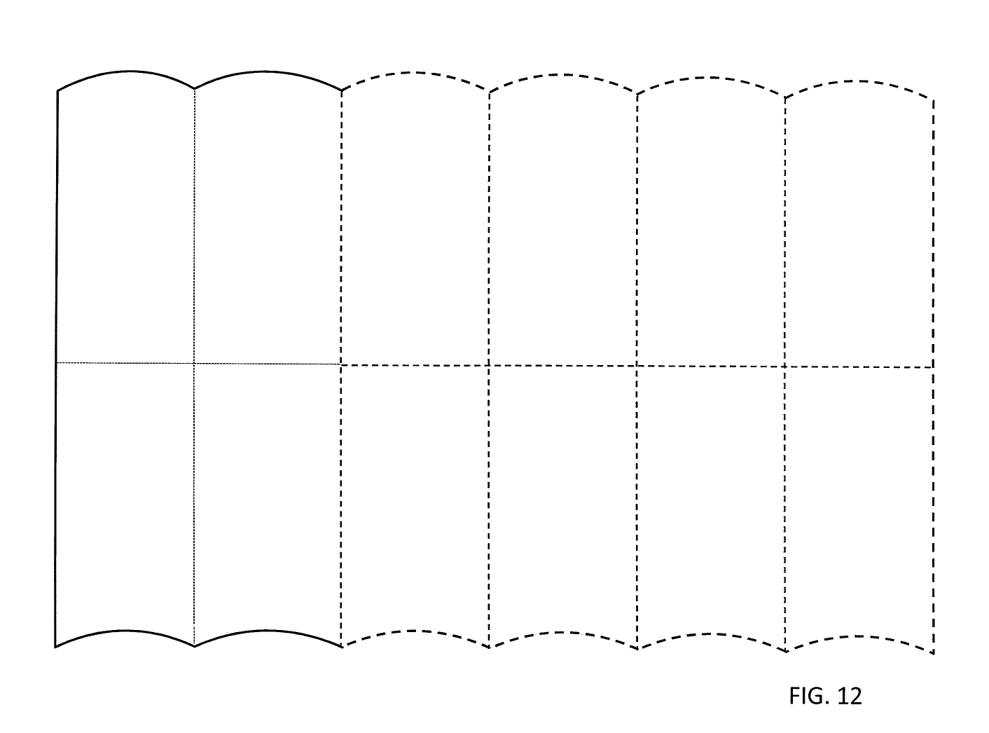

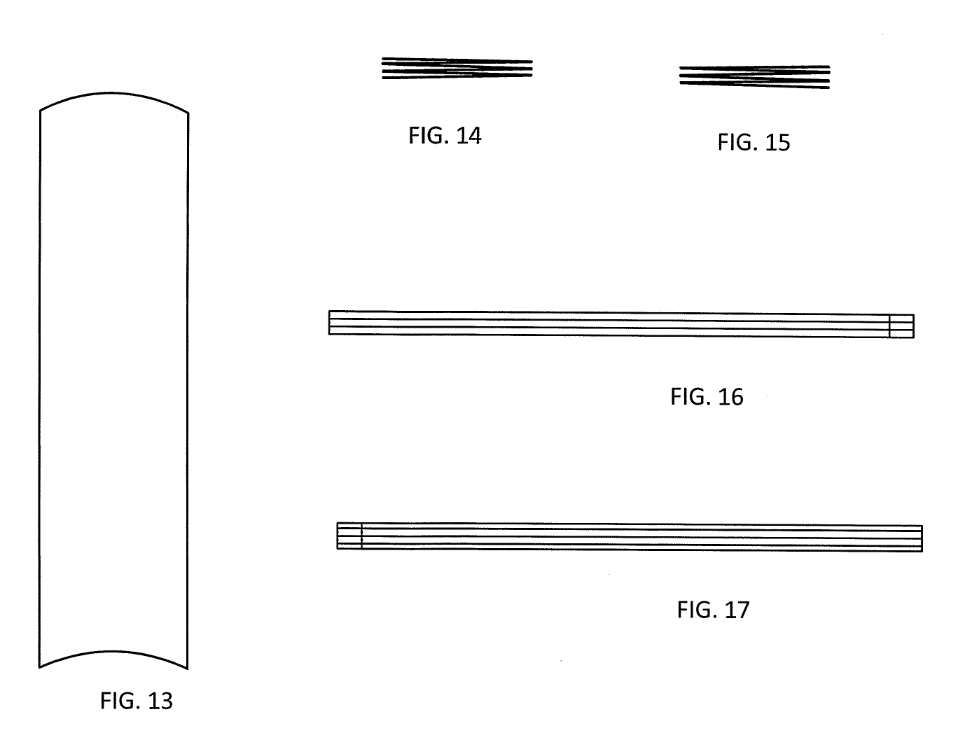

FIG. 12 shows an ornamental view of an unfolded towelette of the invention. The broken lines form no part of the claim. FIGS. 13-17 show ornamental views of the pleat-folded towelette of the invention.

What is claimed is:

1. A method for cutting a pleat-folded web material into a plurality of pleat-folded towelettes, comprising the steps of:
1) providing a cutting station that includes a rotary knife that rotates around an axis, the rotary knife including at least one blade having a non-linear cutting edge;
2) passing continuously a pleat-folded web through the cutting station in a direction transverse to the axis of the rotary knife;
3) rotating the rotary knife in a rotation direction of the passing through direction of the pleat-folded web, to sever the pleat-folded material with the non-linear cutting edge at a predetermined length and along a non-linear cutting line, to form a plurality of pleat-folded towelettes.

2. The method according to claim 1, wherein the at least one blade has a curved cutting edge.

3. The method according to claim 2, wherein the curved cutting edge is oriented parallel to the axis of the rotary knife, and has a radius R that is about 1 to 1.5 times the radial distance of the curved cutting edge from the axis of the rotary knife.

4. The method according to claim 2, wherein a width of the curved cutting edge along the axis of the rotary knife is greater than a width of the pleat-folded web.

5. The method according to claim 2, wherein the pleat-folded web is severed by the curved cutting edge of the rotary knife making crush cut contact with a rotating anvil drum as the pleat-folded web passes through the cutting station between the rotary knife and the anvil drum.

6. The method according to claim 2, wherein the curved cutting edge includes a center portion and two end portions, and wherein the blade is oriented on the rotary knife so that the two end portions lead the cutting edge into the pleat-folded web.

7. The method for cutting according to claim 1, wherein a tangential speed of the rotating cutting edge is synchronized to the linear speed of the pleat-folded web passing though the cutting station.

8. A rotary knife for cutting a towelette from a web of continuously longitudinally moving pleat-folded material, comprising a rotary drum and at least one non-linear blade extending from a periphery of the rotary drum, the at least one non-linear blade having a non-linear cutting edge.

9. The device according to claim 8, wherein the entire cutting edge is displaced a same radial distance from an axis of the rotary drum.

10. The device according to claim 9, wherein the non-linear cutting edge is a curved cutting edge two end portions oriented parallel to the axis of the rotary drum.

11. The device according to claim 8, wherein the blade is part of an insert that can be secured to a complimentary channel in the rotary drum.

12. The device according to claim 11, wherein the insert comprises a plurality of blades.

13. The device according to claim 11, wherein the rotary knife comprises a plurality of inserts.
